(19) United States
(12) Patent Application Publication
(10) Pub. No.: US 2005/0113032 A1
(43) Pub. Date: May 26, 2005

(54) Reception system including a pointing aid device

(76) Inventor: Franck Adam, Rennes (FR)

Correspondence Address: THOMSON LICENSING INC., PATENT OPERATIONS, PO BOX 5312, PRINCETON, NJ, 08543-5312, US

(21) Appl. No.: 10/993,271

(22) Filed: Nov. 19, 2004

(30) Foreign Application Priority Data
Nov. 21, 2003 (EP) 03 292 889.7
Jan. 6, 2004 (FR) 04/00138

(51) Int. Cl. H04B 7/14

(52) U.S. Cl. 455/67.11

(57) ABSTRACT

The invention is a radio wave reception system which comprises an indoor unit equipped with reception means and means for measuring the received signal strength, an outdoor unit linked to the indoor unit by at least one coaxial cable, the outdoor unit being securely attached to an antenna that must point to a remote transmitter, mechanical adjustment means for adjusting the positioning of the antenna, aid means for providing an operator with operator adjustment instructions, with which means the operator can interact. The invention is also an assisted antenna pointing method.

### FIELD OF THE INVENTION

The invention relates to a reception system including a pointing aid device. The invention relates more specifically to the reception systems requiring highly accurate, inexpensive pointing, such as, for example, the consumer satellite reception systems equipped with a return channel.

### STATE OF THE ART

Satellite communication systems require accurate alignment of the antenna with the satellite to set up the link. Satellite TV reception systems in the C band (4-6 GHz) and in the Ku band (11-12 GHz) need a pointing accuracy of around 10 to 20. The pointing techniques used provide an adjustment of the alignment of around 0.4° with the satellite. This alignment is manual, and performed either by a professional installer or by the individual. It is also known that information representing the received strength is needed to perform this type of adjustment.

For bi-directional systems, that is, with a transmitter, the pointing must be more accurate for two main reasons. A first reason is that if the pointing is inaccurate, the transmit channel of the user terminal creates a disturbance on the adjacent satellites, and disrupts their communication system. A second reason is that the antenna subsystem has a higher gain in transmission than in reception (to minimize the transmit power), and therefore the main beam is finer, hence the need for a more accurate pointing of around 0.10.

An installer must therefore carry out accurate pointing which may require expensive equipment to locate the antenna accurately enough relative to the satellite. Such a pointing operation can also take a long time.

### SUMMARY OF THE INVENTION

The invention provides a pointing aid device to help an installer point the antenna more quickly. For this, aid means are used to guide the installer to obtain a finer adjustment. The aid means guide the operator to take additional measurement points and determine a correction to be made.

The invention is a radio wave reception system which comprises an indoor unit equipped with reception means and means for measuring the received signal strength, an outdoor unit linked to the indoor unit by at least one coaxial cable, the outdoor unit being securely attached to an antenna that must point to a remote transmitter, mechanical adjustment means for adjusting the positioning of the antenna, aid means for providing an operator with operator adjustment instructions and with which the operator can interact.

Preferably, the aid means can include a processing means placed in the indoor unit which generates instructions for the operator according to signal strength measurements, and an outdoor module enabling the operator to receive the instructions and send end-of-adjustment information to the indoor unit. The outdoor module can include a pushbutton, a headset and a connection designed to be linked to the indoor unit. The connection can be designed to be linked to a satellite return channel. The connection can be designed to be linked to an audio output of the outdoor unit. The instructions can include prerecorded messages, composed according to the strength measurements.

The invention is also an assisted antenna positioning method for the reception system in which a rough adjustment is made to obtain a rough pointing of the antenna, followed by a series of fine adjustment steps in which the operator is guided to take measurement points corresponding to a rotation of the antenna from the rough pointing to determine the optimum setting.

During the series of rough adjustment steps, the operator can move the antenna freely while receiving information representing the strength of a received signal. The information representing the strength of the received signal can be a sound amplitude- and/or frequency-modulated according to the strength of the received signal.

On completion of the series of rough adjustment steps, the received signal strength measurement is stored, and the series of fine adjustment steps can comprise the following steps:
rotation by a determinable quantity in azimuth and/or elevation relative to the position corresponding to the rough adjustment in a first direction and storage of the received signal strength,
rotation by a determinable quantity in azimuth and/or elevation relative to the position corresponding to the rough adjustment in a second direction opposite to the first direction and storage of the received signal strength,
calculation of an optimum position according to the storage of the signal strengths measured and output of adjustment information to the operator according to the calculation performed.

The end of each rotation step can be determined by the operator pressing a pushbutton which initiates storage of the received signal strength.

### LIST OF FIGURES

The invention will be better understood, and other particular features and advantages will emerge on reading the description that follows, the description referring to the appended drawings in which:

FIG. 1 represents a satellite reception system;

FIG. 2 functionally represents a preferred embodiment of the invention;

FIG. 3 represents the embodiment of FIG. 2 in greater detail.

### DETAILED DESCRIPTION

FIG. 1 represents a satellite reception system which comprises an antenna 1 which includes an outdoor reception unit 2, an indoor reception unit 3 which converts the received signal into a useful signal for a user appliance 4, and at least one link cable 5 linking the outdoor unit 2 and the indoor unit 3. The object of the invention is to improve the pointing of the antenna in particular for a reception system having a return channel, in other words a bidirectional system. Although it can be used for a unidirectional reception system, the system described below is a bidirectional system.

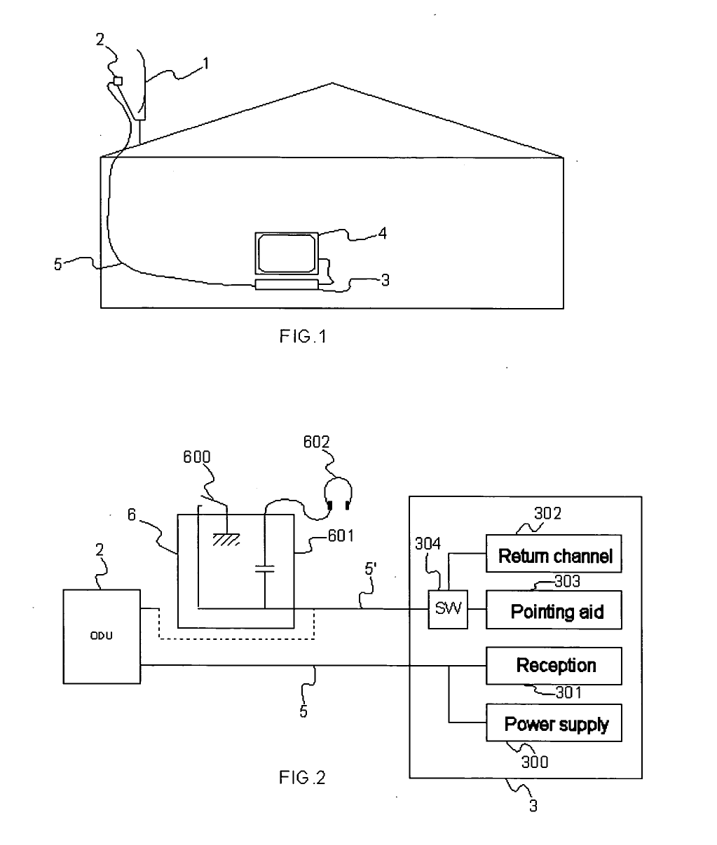

FIG. 2 details an embodiment of the invention in which the link between the outdoor unit 2 and the indoor unit 3 is, in receive mode, via a coaxial cable 5 for reception and via a coaxial cable 5′ for transmission. The coaxial cable 5′ is also used for adjusting the positioning of the antenna to reduce the cables to be used. Thus, according to the invention, the cable 5′ is connected to an outdoor module 6 instead of to a return channel terminal of the outdoor unit 2 (represented by the dotted link).

The outdoor unit 2 is an outdoor unit of a known type, for example a bi-directional LNB, and will not be described in greater detail. The indoor unit 3 is, for example, a satellite decoder including a return channel for interactive programs. The indoor unit 3 mainly comprises LNB power supply means 300, reception means 301, return channel means 302 and pointing aid means 303. The power supply means 300 and the reception means 301 are linked to the reception cable 5 according to a known technique. The power supply means 300 also include control means used to control the LNB, for example, according to the DiSEqC standard. The return channel means 302 and the pointing aid means 303 are linked to the cable 5′ via a switch 304.

The outdoor module 6 is equipped with a pushbutton 600 which applies a short circuit to the cable 5′. A capacitor 601 links the central core of the cable 5′ to headphones 602.

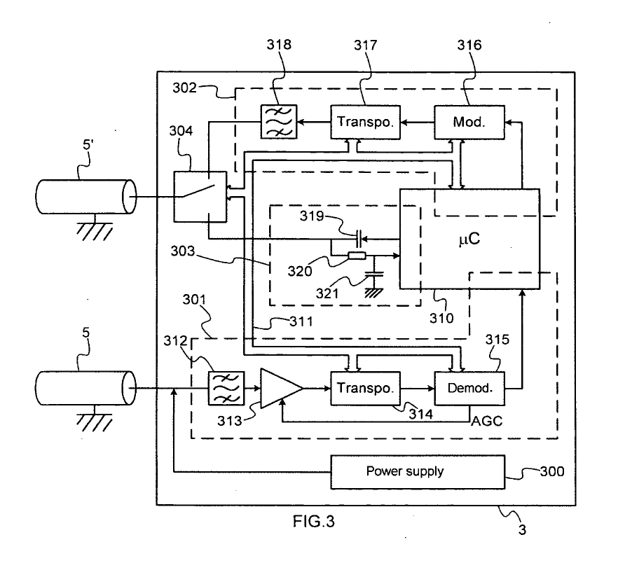

FIG. 3 more structurally details the indoor unit 3 which is built around a micro controller 310, for example, the circuit referenced ST15516 produced by STMicroelectronics. The micro controller 310 has a memory and a processor enabling it to perform a number of control and processing functions on the set of resources which make up the indoor unit 3. The micro controller 310 also has a plurality of inputs/outputs, some of them binary and others analog, and at least a control bus 311, for example an 12C bus, which is used to send commands and exchange data with the other elements that make up the indoor unit 3.

The reception means 301 comprise a band pass filter 312 which selects the signals from the satellite intermediate band from the cable 5 to supply said signals to a variable gain amplifier 313. The signals amplified by the amplifier 313 are supplied to a transposition circuit 314 which transposes a channel selected from the intermediate frequency band into the base band. The transposition circuit includes a frequency synthesizer controlled by the micro controller 310 via the bus 311. A demodulation circuit 315 transforms the base band channel into a bit stream corresponding to the demodulated signal. The bit stream is supplied to a binary input of the micro controller 310 which processes and formats the received data then supplies it to the user appliance 4. The demodulation circuit 315 is, for example, the circuit referenced STV299 produced and marketed by STMicroelectronics. This demodulation circuit 315 is monitored and controlled by the micro controller 310 which can read and write in registers of said demodulation circuit 315. Among the registers of the demodulation circuit 315, one of the registers corresponds to the AGC amplification set point which is sent to the variable gain amplifier 313 and another register corresponds to a strength measurement of the signal received from the transposition circuit 314. The combination of the content of these two registers provides a relatively accurate measurement of the received signal for a given channel.

The return channel means 302 comprise a modulation circuit 316 which receives a bit stream originating from the micro controller 310 and modulates it in the base band. The modulated signals are then transposed by a transposition circuit 317 then filtered by the filter 318 to then be supplied to the cable 5′ via the switch 304.

The pointing aid means 303 are mainly implemented using the micro controller 310 which supplies an audio signal to an analog output linked to the switch 304 via a capacitor 319. To detect the short circuits applied by the pushbutton 600, a binary input of the micro controller 310 is linked to the switch 304 via a resistor 320, the binary input also being linked to ground via a capacitor 321 which is used to eliminate the audible frequencies. The binary input also has high level pull-up means.

Since the power supply means 300, reception means 301 and return channel means 302 are already known, only the operation of the aid means 303 will now be detailed.

Firstly, the operator indicates to the indoor unit 3 that the latter is operating in pointing aid mode. The micro controller 310 positions the switch 304 to link the aid means 303 to the cable 5′. The operator can then move near to the antenna 1 and connect the outdoor module 6 to the cable 5′ and the cable 5 to the outdoor unit 2.

To position the antenna, there are two possibilities that can be envisaged. The first possibility is that the antenna is only equipped with fixing means simply enabling the antenna to be secured in a given position relative to a support mast. The operator must place a mechanical positioning device, as is known from the prior art. The positioning device secures the antenna and has adjusting screws to adjust the position of the antenna in azimuth and in elevation. When positioning is complete, the fixing means are secured and the positioning device can be removed. The second possibility is that the antenna fixing means include azimuth and elevation adjusting screws. In both cases, the operator will have the possibility of acting on the position of the antenna directly or via adjusting screws.

First of all, the operator very roughly and very approximately positions the antenna by moving it manually. Before doing this, he or she presses, for example, the pushbutton to signal the start of the positioning to the indoor unit 3. The micro controller 310 positions the reception means on a channel of the satellite to be pointed to which is known in advance. Then the registers of the demodulator 315 are read periodically, for example every tenth of a second, by the micro controller to measure the signal strength for this channel. On each strength measurement, the micro controller creates a signal with a frequency and amplitude dependent on the measured strength, this signal is supplied by the analog output of the micro controller. In the example, the signal is created in such a way that, the stronger the received signal strength, the higher the frequency of the signal generated and the greater its amplitude. The operator listens to the signal in the headphones and moves the antenna until he or she hears the loudest and most high-pitched sound. This type of positioning is already known and can be used to position an antenna with an accuracy of less than 0.4°. When the antenna is roughly positioned the operator presses the pushbutton to signal the end of the rough positioning. The micro controller 310 then stores the measured signal strength which is referred to below as P_{g}.

Next comes a series of fine antenna positioning adjustment steps. A prerecorded message in a memory of the micro controller 310 is sent to the operator via the analog output of the micro controller 310 and the headphones 602 to indicate rotation of the antenna in azimuth by 0.4° to the west. Such a movement can be achieved relatively accurately using the adjusting screws that are normally graduated. When the movement has been made, the operator presses the pushbutton, which triggers storage of the received signal strength with this rotation, designated Pₐ. Another message is then sent to the operator to indicate movement of the antenna in azimuth by 0.8° to the east. The operator presses the button once the movement has been made, and the received signal strength is again stored, designated P_{b}.

The pointing error obtained in the rough positioning method is then given by the following formula:
E=arctan((Pa−Pb)/(Pa+Pb)*cotan(N*D))/N
in which:
E is the pointing error to be determined
arctan is the reciprocal of the tangent function
cotan is the inverse of the tangent function
/ represents a division
* represents a multiplication
D is the angular pointing error value (in the example 0.4°)
N is a parameter of the antenna such that the main radiating lobe of the antenna is approximated by the function:
P=P0*cos(N*a), with P0 being the maximum radiating power of the antenna at its center, and P being the radiated power on moving away from the radiating center of the antenna by an angle a.

This formula is derived from the phase shift obtained between the angular position corresponding to the signal strength P_{g} and the angle corresponding to the maximum of a curve representing the main radiating lobe of the antenna which passes through the three points measured by applying the least-squares method. Other approximations of the main radiating lobe of the antenna are possible.

At the end of the calculation, the micro controller sends a message to the operator to tell him or her to adjust the setting by E° in azimuth relative to the position corresponding to the rough setting. Once the adjustment is complete, the operator presses the pushbutton and stores the corresponding signal strength and takes it as the new reference signal strength Pᵣ.

A message is then sent to the operator to indicate rotation of the antenna in elevation by 0.4° upward. The operator makes the adjustment using the elevation adjusting screws. When the movement has been completed, the operator presses the pushbutton, which initiates storage of the received signal strength with this rotation, giving a new signal strength Pₐ. Another message is then sent to the operator to indicate movement of the antenna in elevation by 0.80 downward. The operator presses the button once the movement has been completed, and the received signal strength is again stored, as a new signal strength P_{b}. The micro controller 310 calculates the error correction in elevation to be made with the abovementioned formula then outputs a message to the operator indicating the correction to be made.

The operator can then definitively lock the antenna in position. Such a method of adjustment provides a pointing accuracy of less than 0.05°.

Some improvements can be envisaged. The messages sent to the operator can be of various types. A first message type consists in indicating to the operator the offsets in degrees to be made using the fine adjusting screws. The operator must then memorize the angular shift that corresponds to one turn of the adjusting screw.

A second type of message can be made up of messages indicating the number of turns or quarter turns to be applied to the adjusting screws. For this, various fine adjustment means are stored in the indoor unit 3 to match the angular offset produced by one turn of the screw to each type of adjustment means. When setting said indoor unit 3 to the pointing aid mode, the operator is asked to identify the fine adjustment means by giving the reference of the antenna or of the adjustment device used. The messages sent to the operator will then indicate to the operator the screw to be turned, the number of turns or quarter turns to be made and the direction in which the screw must be turned.

It is possible to take the four measurement points directly without performing an intermediate realignment to estimate the error in azimuth and elevation simultaneously.

Equally, the signal strength measurements with a known rotation can be made with a greater number of points to obtain a greater accuracy on the error.

If the rough pointing method is done very badly and the pointing error is greater than the misalignment angle, it is best to perform a second fine adjustment method. A second systematic method also means that the final pointing will be truly certain.

Variants are possible. The preferred example which has just been described uses two coaxial cables, one for reception and one for the return channel. It is possible to use a single cable for transmission and reception. It then becomes difficult to convey the aid information to the operator. However, the satellite decoders normally have sound output connectors, typically RCA sockets. It is then appropriate to use a sound output to send the message to the operator. However, one drawback is that the operator has to temporarily pull an additional cable between the antenna and the indoor unit.

1. Radio wave reception system comprising:
an indoor unit equipped with reception means and means for measuring the received signal strength,
an outdoor unit linked to the indoor unit by at least one coaxial cable, the outdoor unit being securely attached to an antenna that must point to a remote transmitter, wherein it comprises:
mechanical adjustment means for adjusting the positioning of the antenna,
aid means for providing an operator with operator adjustment instructions and with which the operator can interact.

2. System according to claim 1, wherein the aid means include a processing means placed in the indoor unit which generates instructions for the operator according to signal strength measurements, and an outdoor module enabling the operator to receive the instructions and send end-of-adjustment information to the indoor unit.

3. System according to claim 2, wherein the outdoor module includes a pushbutton, a headset and a connection designed to be linked to the indoor unit.

4. System according to claim 3, wherein at the connection is designed to be linked to a satellite return channel.

5. System according to claim 3, wherein the connection is designed to be linked to an audio output of the outdoor unit.

6. System according to claim 1, characterized in that the instructions include prerecorded messages, composed according to the strength measurements.

7. Method of assisted antenna positioning in a reception system according to claim 1, wherein it comprises:
a rough adjustment to obtain a rough pointing of the antenna,
a series of fine adjustment steps in which the operator is guided to take measurement points corresponding to a rotation of the antenna from the rough pointing to determine the optimum setting.

8. Method according to claim 7, wherein during the series of rough adjustment steps, the operator freely moves the antenna while receiving information representing the strength of a received signal.

9. Method according to claim 8, wherein the information representing the strength of the received signal is a sound amplitude- and/or frequency-modulated according to the strength of the received signal.

10. Method according to claim 7, wherein on completion of the series of rough adjustment steps, the received signal strength measurement is stored, and in that the series of fine adjustment steps comprises the following steps:
rotation by a determinable quantity in azimuth relative to the position corresponding to the rough adjustment in a first direction and storage of the received signal strength,
rotation by a determinable quantity in azimuth relative to the position corresponding to the rough adjustment in a second direction opposite to the first direction and storage of the received signal strength,
calculation of an optimum position according to the storage of the signal strengths measured and output of adjustment information to the operator according to the calculation performed.

11. Method according to claim 7, wherein on completion of the series of rough adjustment steps, the received signal strength measurement is stored, and in that the series of fine adjustment steps comprises the following steps:
rotation by a determinable quantity in elevation relative to the position corresponding to the rough adjustment in a first direction and storage of the received signal strength,
rotation by a determinable quantity in elevation relative to the position corresponding to the rough adjustment in a second direction opposite to the first direction and storage of the received signal strength,
calculation of an optimum position according to the storage of the signal strengths measured and output of adjustment information to the operator according to the calculation performed.

12. Method according to claim 10, wherein the end of each rotation step is determined by the operator pressing a pushbutton which initiates storage of the received signal strength.
